(19) United States
(12) Patent Application Publication
(10) Pub. No.: US 2008/0019347 A1
(43) Pub. Date: Jan. 24, 2008

(54) Wireless network system and method of transmitting-receiving data over wireless network

(75) Inventors: Se-young Shin, Suwon-si (KR); Chang-yeul Kwon, Yongin-si (KR); Guoping Fan, Suwon-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD., Suwon-si (KR)

(21) Appl. No.: 11/783,172

(22) Filed: Apr. 6, 2007

Related U.S. Application Data
(60) Provisional application No. 60/831,473, filed on Jul. 18, 2006.

(30) Foreign Application Priority Data
Sep. 13, 2006 (KR) 10-2006-0088725

(51) Int. Cl. H04J 3/00

(52) U.S. Cl. 370/345

(57) ABSTRACT

A wireless network system and a method of transmitting/receiving data over a wireless network, and more particularly, for transmitting/receiving data over a wireless network capable of allowing a station that has not received a beacon frame or has received a damaged beacon frame among stations performing wireless communication in a high-frequency band to acquire schedule information in a super frame. A wireless network coordinator according to an exemplary embodiment of the invention includes: a media access control (MAC) unit that generates a beacon frame for forming a super frame including one or more channel time blocks; a band managing unit that allows a station on a network to set a specific channel time block among the channel time blocks to a period in which a packet including a predetermined control command is transmitted or received; and a transmitting unit that transmits the beacon frame including information on the setting through a predetermined communication channel.

### CROSS REFERENCE TO RELATED APPLICATION

This application claims priority from Korean Patent Application No. 10-2006-88725 filed on Sep. 13, 2006 in the Korean Intellectual Property Office, and U.S. Provisional Patent Application No. 60/831,473 filed on Jul. 18, 2006 in the United States Patent and Trademark Office, the disclosures of which are incorporated herein by reference in their entirety.

### BACKGROUND OF THE INVENTION

1. Field of the Invention

Methods and apparatuses consistent with the invention relate to a wireless network system and a method of transmitting/receiving data over a wireless network, and more particularly, for transmitting/receiving data over a wireless network capable of allowing a station that has not received a beacon frame or has received a damaged beacon frame among stations performing wireless communication in a high-frequency band to acquire schedule information in a super frame.

2. Description of the Related Art

FIG. 1 is a diagram illustrating a half-duplex wireless network using a request to send (RTS) signal and a clear to send (CTS) signal according to the related art.

In general, wireless networks use a half-duplex mode that cannot perform data transmission and reception at the same time. When the wireless network uses the half-duplex mode to access a wireless medium, an RTS signal 111 and a CTS signal 121 are used to prevent the collision of access signals to the medium.

First, a transmitting station 110 having a frame to be transmitted transmits the RTS signal 111 to start a transmission procedure. Then, all peripheral stations having received the RTS signal 111 stops generating radio waves. When a receiving station 120 receives the RTS signal 111, the receiving station 120 transmits the CTS signal 121 as a response. The CTS signal 121 also prevents all the peripheral stations from generating radio waves. The transmitting station 110 having received the CTS signal 121 transmits a frame 112 to the receiving station 120. Then, the receiving station 120 transmits an acknowledge signal 122 to the transmitting station 110 as a response, and the transmitting station 110 receives the acknowledge signal 122.

Carrier sense multiple access with collision avoidance CSMA/CA), which is a media access control (MAC) algorithm generally used in a wireless local area network (LAN) environment, is provided by a distributed coordination function (DCF). The distributed coordination function checks whether a wireless link is clear before the transmitting station 110 transmits the frame 120 and uses back-off at the end point of each frame 112 in order to prevent collision with other stations, similar to Ethernet.

Carrier sensing is used to determine whether a medium is available, and is divided into a physical carrier sensing function and a virtual carrier sensing function. The physical carrier sensing function is provided in a physical layer, and depends on a medium used and a modulation mode. A network allocation vector (NAV) provides the virtual carrier sensing, and is a timer indicating time information when a medium is reserved. The network allocation vector is included in a frame header of each of the RTS signal 111 and the CTS signal 121 and is then transmitted. The transmitting station 110 and the receiving station 120 set the time required to complete their operations to the network allocation vector and thus prevents other stations from using the medium.

Meanwhile, timing is based on a super frame in a wireless personal area network (PAN) environment.

FIG. 2 is a diagram illustrating a super frame according to the related art. As shown in FIG. 2, the super frame 200 includes a beacon period 210, a contention access period 220, and a channel time allocation period 230 in this order. For example, asynchronous data or control command is transmitted or received in the contention access period 220. The channel time allocation period 230 includes channel time allocation (CTA) 232 and management CTA (MCTA) 231. For example, a control command, isochronous data, or asynchronous data is transmitted or received through the CTA 232.

The length of the contention access period 220 depends on an access point, and the contention access period 220 is transmitted to the stations taking part in the network through the beacon frame distributed in the beacon period 210.

CSMA/CA is used as a media access method in the contention access period 220. On the other hand, the channel time allocation period 230 uses a time division multiple access (TDMA) system in which a specific time window is provided for every station. An access point allocates a channel time for an apparatus that requests a media access and transmits or receives data to or from a corresponding station during that period. The MCTA 231 is allocated to a pair of stations that want to transmit/receive data and is used as a shared CTA that accesses the TDMA system or uses a slotted aloha protocol.

A method of transmitting compressed data through a frequency band of several gigahertz (GHz) and a method of transmitting uncompressed data through a frequency band of several tens of gigahertz have been used to transmit data. Since the uncompressed data has a size considerably larger than that of the compressed data, the uncompressed data can be transmitted through only a frequency band of several tens of gigahertz. In addition, even when the loss of packets occurs during transmission, the output of the uncompressed data is less affected than the compressed data.

In the wireless communication, the beacon frame includes schedule information on access to a network medium. That is, the stations on the network can check the arrangement of the contention access period and the channel time allocation period through the beacon frame and access the medium or suspend access to the medium.

Meanwhile, the station may not receive the beacon frame or may receive a damaged beacon frame due to problems in the network or its own problems. In this case, since the schedule information of the network is not supplied to the station, a corresponding super frame is ended, which makes it difficult for the station to access the medium until the station receives the beacon frame. As a result, the transmission of data by the corresponding station is delayed, which causes the band of the super frame allocated to the station not to be used, resulting in waste of media.

Therefore, a technique for enabling the station that has not received the beacon frame or has received the damaged beacon frame to acquire the schedule information of the network is needed.

### SUMMARY OF THE INVENTION

An aspect of the present invention is to provide a technique for enabling a station that has not received a beacon frame or has received a damaged beacon frame among stations performing wireless communication in a high-frequency band to acquire schedule information in a super frame.

Aspects of the present invention are not limited to those mentioned above, and other aspects of the present invention will be apparently understood by those skilled in the art through the following description.

According to an aspect of the present invention, there is provided a wireless network coordinator including a media access control (MAC) unit generating a beacon frame for forming a super frame including one or more channel time blocks; a band managing unit allowing a station on a network to set a specific channel time block among the channel time blocks to a period in which a packet including a certain control command is transmitted or received; and a transmitting unit transmitting the beacon frame including information on the setting through a certain communication channel.

According to another aspect of the present invention, there is provided a station including a determining unit determining whether a beacon frame is received; a media access control (MAC) unit generating a packet including a first command that is used to request schedule information of a super frame having the beacon frame transmitted thereto according to the result of the determination; and a transmitting unit transmitting the packet including the first command through a specific channel time block of one or more channel time blocks included in the super frame and receiving a packet including a second command for notifying the schedule information, which is a response to the transmitted packet.

According to still another aspect of the present invention, there is provided a method of configuring a network, the method including: generating a beacon frame for forming a super frame including one or more channel time blocks; allowing a station on a network to set a specific channel time block among the channel time blocks to set a period in which a packet including a certain control command is transmitted or received; and transmitting the beacon frame including information on the setting through a certain communication channel.

According to yet another aspect of the present invention, there is provided a method of transmitting/receiving data, the method including: determining whether a beacon frame is received; generating a packet including a first command that is used to request schedule information of a super frame having the beacon frame transmitted thereto according to the result of the determination; transmitting the packet including the first command through a specific channel time block of one or more channel time blocks included in the super frame; and receiving a packet including a second command for notifying the schedule information, which is a response to the transmitted packet.

Details of other exemplary embodiments of the invention are included in the detailed description of the invention and the drawings.

### BRIEF DESCRIPTION OF THE DRAWINGS

The above and other features and aspects of the present invention will become more apparent by describing in detail exemplary embodiments thereof with reference to the attached drawings in which:

FIG. 1 is a diagram illustrating a half-duplex wireless network using an request to send (RTS) signal and a clear to send (CTS) signal according to the related art;

FIG. 2 is a diagram illustrating a super frame according to the related art;

FIG. 3 is a diagram illustrating a wireless network system according to an exemplary embodiment of the invention;

FIG. 4 is a diagram illustrating a communication layer according to the exemplary embodiment of the invention;

FIG. 5 is a diagram illustrating a super frame according to the exemplary embodiment of the invention;

FIG. 6 is a diagram illustrating a control command according to the exemplary embodiment of the invention;

FIG. 7 is a diagram illustrating schedule information according to the exemplary embodiment of the invention;

FIG. 8 is a block diagram illustrating a wireless network coordinator according to the exemplary embodiment of the invention;

FIG. 9 is a block diagram illustrating a station according to the exemplary embodiment of the invention;

FIG. 10 is a flow chart illustrating the operation of the wireless network coordinator according to the exemplary embodiment of the invention; and

FIG. 11 is a flow chart illustrating data transmission/reception by the station according to the exemplary embodiment of the invention.

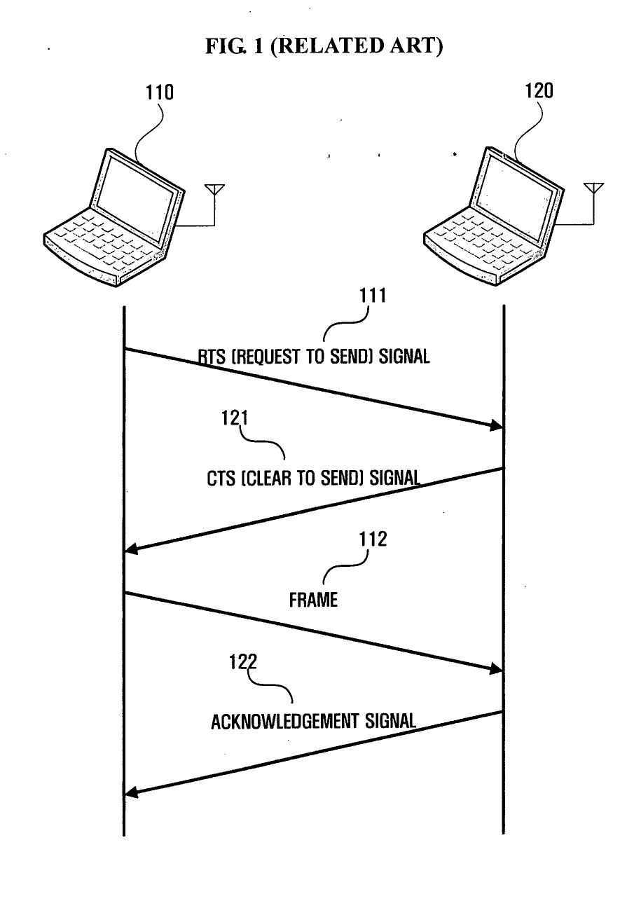

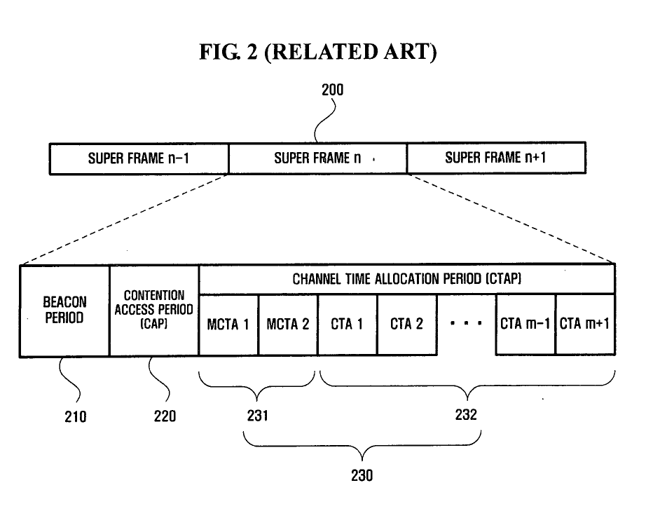

### DETAILED DESCRIPTION OF EXEMPLARY EMBODIMENTS OF THE INVENTION

Aspects and features of the present invention and methods of accomplishing the same may be understood more readily by reference to the following detailed description of exemplary embodiments and the accompanying drawings. The present invention may, however, be embodied in many different forms and should not be construed as being limited to the exemplary embodiments set forth herein. Rather, these exemplary embodiments are provided so that this disclosure will be thorough and complete and will fully convey the concept of the invention to those skilled in the art, and the present invention will only be defined by the appended claims. Like reference numerals refer to like elements throughout the specification.

The present invention will now be described more fully with reference to the accompanying drawings, in which exemplary embodiments of the invention are shown.

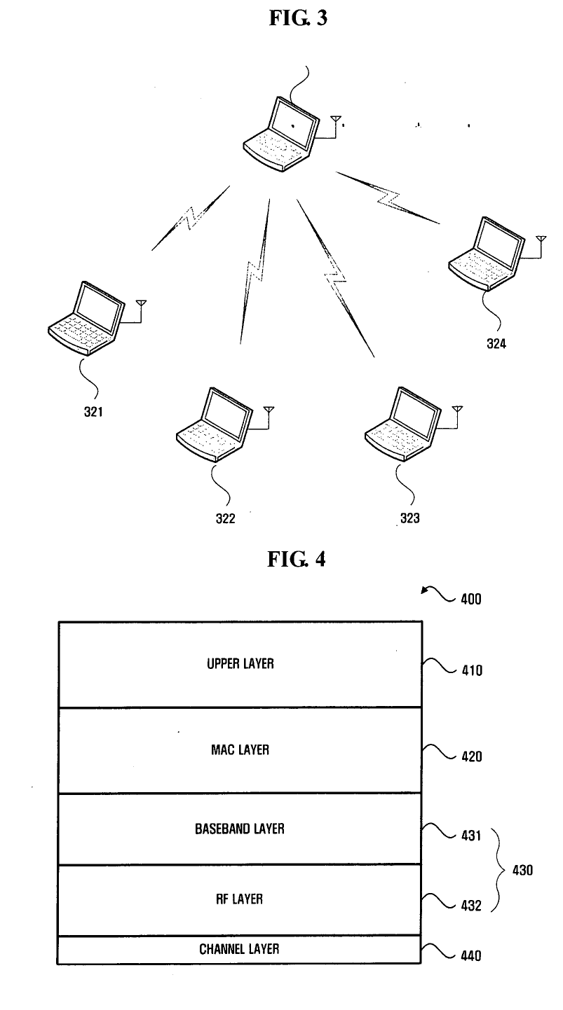

FIG. 3 is a diagram illustrating a wireless network system according to an exemplary embodiment of the invention. The wireless network system includes a wireless network coordinator 310 and wireless network stations 321, 322, 323, and 324.

The wireless network coordinator 310 transmits a beacon frame to adjust the band allocation of the wireless network stations 321, 322, 323, and 324 provided in the wireless network. That is, one or more wireless network stations 321, 322, 323, and 324 forming the wireless network may wait to receive an allocated band with reference to a received beacon frame, or when a band is allocated to one wireless network station, the wireless network station may transmit data to another wireless network station through the allocated band.

The network according to the exemplary embodiment of the invention is configured according to a super frame including one or more channel time blocks. The channel time block is classified into a reserved channel time block, which is a reserved time period in which a band is allocated to a specific wireless network station on the network, and an unreserved channel time block, which is a time period in which a band is allocated to one wireless network station selected from the wireless network stations on the network by contention.

The channel time block means a constant time period in which data is transmitted among the wireless network stations provided in the network, and the reserved channel time block and the unreserved channel time block correspond to a channel time allocation period and a contention access period, respectively.

One wireless network station having data to be transmitted may contend with another wireless network station to transmit the data in the unreserved channel time block, or it may transmit the data in the allocated reserved channel time block. That is, each wireless network station on the network checks the allocation of a band with reference to schedule information included in the beacon frame and transmits/receives data.

One or more unreserved channel time blocks may be included in one super frame. Among them, a specific unreserved channel time block may be set to a period (hereinafter, referred to as a control command period) in which a packet (hereinafter, referred to as a control command packet) including a control command is transmitted or received. The control command includes an information request command that is generated by one of the wireless network stations on the network that has not received the beacon frame or has received a damaged beacon frame to request schedule information on one or more schedule periods included in the super frame and an information response command that is generated by the wireless network coordinator 310 so as to include the schedule information in response to the information request command.

Therefore, a wireless network station that has not received the beacon frame or has received the damaged beacon frame due to problems in the network or its own problems can also acquire the schedule information, transmit data through the allocated reserved channel time block without encroaching on the reserved channel time block allocated to another wireless network station, or transmit data in the unreserved channel time block in contention with other wireless network stations.

The control command period may be arranged immediately behind the beacon period, and the position and size of the control command period are fixed. Therefore, the wireless network station that has not received the beacon frame or has received the damaged beacon frame can acquire schedule information on the entire super frame.

FIG. 4 is a diagram illustrating a communication layer according to the exemplary embodiment of the invention.

In general, a communication layer 400 includes a channel layer 440, which is a bottom layer meaning a physical medium having a certain frequency band in which a radio signal is transmitted, a physical layer 430 including a radio frequency (RF) layer 432 and a baseband layer 431, a media access control (MAC) layer 420, and an upper layer 410. The upper layer 410 arranged on the MAC layer 420 may include a logical link control (LLC) layer, a network layer, a transmission layer, and an application layer.

A wireless channel according to the exemplary embodiment of the invention may include a high-frequency band of 60 GHz as well as a low-frequency band of 2.4 GHz or 5 GHz. Therefore, the channel layer 440 can perform both omnidirectional communication and unidirectional communication.

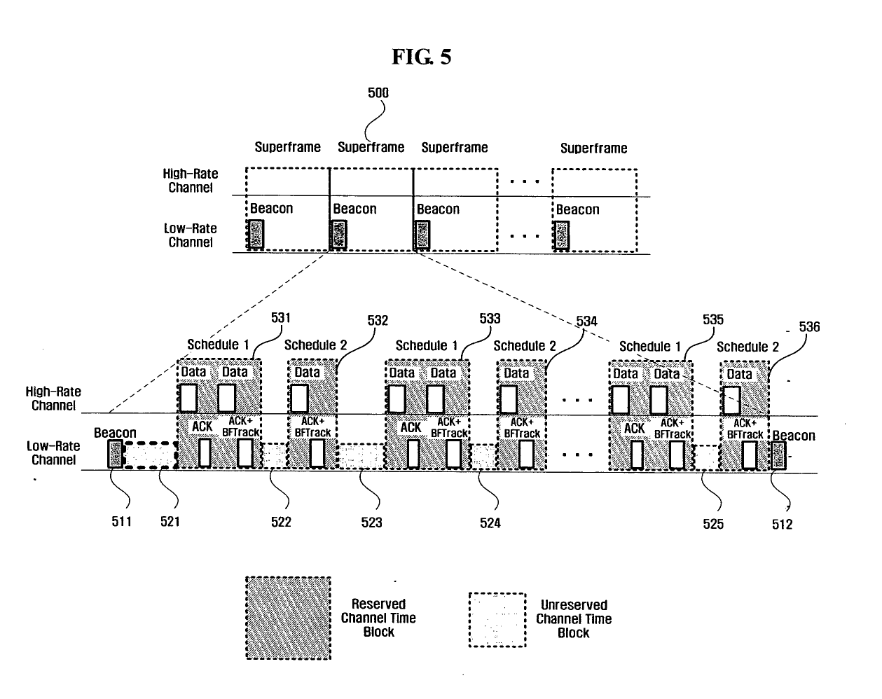

FIG. 5 is a diagram illustrating a super frame according to the exemplary embodiment of the invention. A super frame 500 includes a beacon period, unreserved channel time blocks 521, 522, 523, 524, and 525, and reserved channel time blocks 531, 532, 533, 534, 535, and 536.

A beacon frame 511 is distributed by the wireless network coordinator during the beacon period. Therefore, the wireless network stations having received the beacon frame 511 can know the allocation state of bands on the network on the basis of the schedule information included in the beacon frame 511.

Two or more wireless network stations that want to transmit data contend with one another in the unreserved channel time blocks 521, 522, 523, 524, and 525, and only the wireless network station selected by the contention can transmit the data through the allocated band.

A band is allocated to a specific wireless network station in the reserved channel time blocks 531, 532, 533, 534, 535, and 536, and only the specific wireless network station having received the band can transmit data through the allocated band.

As shown in FIG. 5, the one super frame 500 may include one or more unreserved channel time blocks 521, 522, 523, 524, and 525 and one or more reserved channel time blocks 531, 532, 533, 534, 535, and 536. Among them, a specific unreserved channel time block 521 may be set to the control command period.

That is, among the wireless network stations on the network, the wireless network station that has not received the beacon frame 511 or has received the damaged beacon frame transmits a packet including the information request command in the control command period, and the wireless network coordinator having received the packet generates and distributes a packet including an information response command in response to the packet including the information request command. Then, the wireless network station that has not received the beacon frame 511 or has received the damaged beacon frame can acquire the schedule information before the next beacon frame 512 is distributed.

Since the information response command includes the schedule information of a corresponding super frame, the wireless network station that has not received the beacon frame 511 or has received the damaged beacon frame can also utilize the channel time block of the super frame on the basis of the schedule information acquired through the information response command.

Meanwhile, the control command period is the unreserved channel time block, and the wireless network stations contend with one another to transmit packets in the control command period. In this case, the packets may be transmitted/received by a carrier sense multiple access with collision avoidance method or a slotted aloha method.

As shown in FIG. 5, data has a large size, such as multimedia data, may be transmitted through a high-speed frequency channel, but data having a small size, such as a packet including the beacon frames 511 and 512 and control commands, may be transmitted through a low-speed frequency channel. In this case, the high-speed frequency channel may include a band of 60 GHz, and the low-speed frequency channel may include a band of 2.4 GHz or 5 GHz. The high-speed frequency channel may be a unidirectional channel, and the low-speed frequency channel may be an omnidirectional channel. Alternatively, both the high-speed frequency channel and the low-speed frequency channel may be a bidirectional channel. In this case, each of the wireless network coordinator 310 and the wireless network stations 321, 322, 323, and 324 may have two PHY layers taking charge of the two channels.

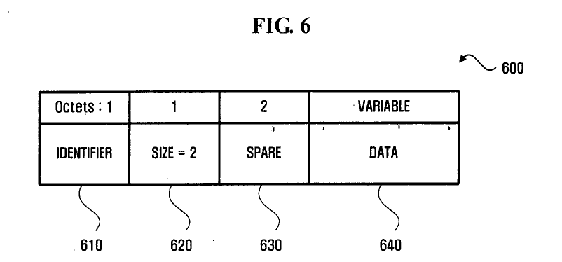

FIG. 6 is a diagram illustrating a control command according to the exemplary embodiment of the invention. As shown in FIG. 6, a control command 600 includes an identifier field 610, a size field 620, a spare field 630, and a data field 640.

The identifier field 610 includes an identifier indicating whether a corresponding command is an information request command or an information response command. A value indicating the size of the spare field 630 may be included in the size field 620, and various values used to smoothly operate the network may be included in the spare field 630.

The information request command is generated by the wireless network station, and the wireless network station that has not received the beacon frame or has received the damaged beacon frame generates a packet including the information request command and transmits the packet in the control command period. Then, the wireless network coordinator generates an information response command including schedule information in response to the received packet and transmits a packet including the information response command. The schedule information may be included in the data field 640 of the information response command, and the size of the data field 640 may vary. When the control command is an information request command, the data field 640 may not be included in the information request command.

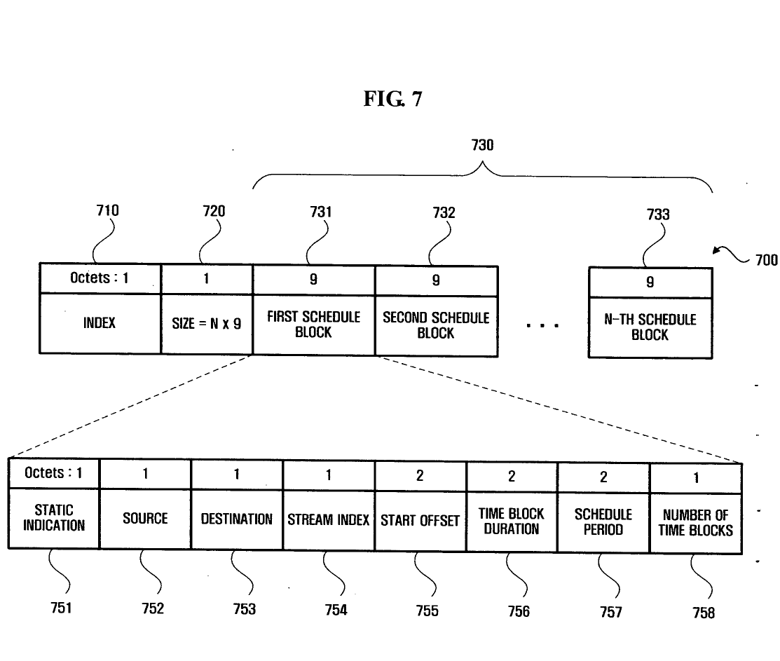

FIG. 7 is a diagram illustrating schedule information according to the exemplary embodiment of the invention. Schedule information 700 may include an index field 710, a size field 720, and one or more schedule blocks 730.

A flag or a unique identifier indicating that corresponding information is schedule information is specified in the index field 710, and the overall size of the schedule block is specified in the size field 720.

At least one of a static indication field 751, a source field 752, a destination field 753, a stream index field 754, a start offset field 755, a time block duration field 756, a schedule period field 757, and a number of time blocks field 758 is included in each of the schedule blocks 731, 732, and 733.

An identifier indicating whether a corresponding schedule block is used for a static schedule is specified in the static indication field 751. For example, the static indication field 751 indicates the schedule of a channel time block existing at a certain time in a certain period in the super frame. When a corresponding schedule block is for the static schedule, a value of 1 may be input to the static indication field 751. On the other hand, when a corresponding schedule block is for a dynamic schedule, a value of 0 may be input to the static indication field 751.

An identifier indicating a transmission wireless network station that is allowed to allocate a band to one of the channel time blocks in the super frame is specified in the source field 752.

An identifier indicating a receiving wireless network station that receives corresponding data from the transmission wireless network station transmitting the data through a channel time block allowed to allocate a band is specified in the destination field 753.

A stream index assigned by the wireless network coordinator is specified in the stream index field 754, which indicates the type of data that is assigned to be received or transmitted in the channel time block. For example, when a wireless network station requests to generate an isochronous stream, an unassigned stream index may be specified in the stream index field 754. In this case, the stream index may be a value defined by the wireless network station. Meanwhile, when the wireless network station requests to reserve or remove an asynchronous channel time block, the stream index may be set to an asynchronous stream value.

Further, the stream index may be set to a value for requesting to revise or remove the existing schedule. That is, the stream index may be set to a value for reserving a band. When the value for reserving a band is specified in the stream index field 754, a corresponding packet may mean a packet to request to allocate a band.

A start time of a schedule period corresponding to a schedule block is specified in the start offset field 755.

A gap between the channel time blocks included in the schedule period is specified in the time block duration field 756.

A time interval between two continuous channel time blocks included in the schedule period is specified in the schedule period field 757.

The number of channel time blocks included in the schedule period is specified in the number of time blocks field 758.

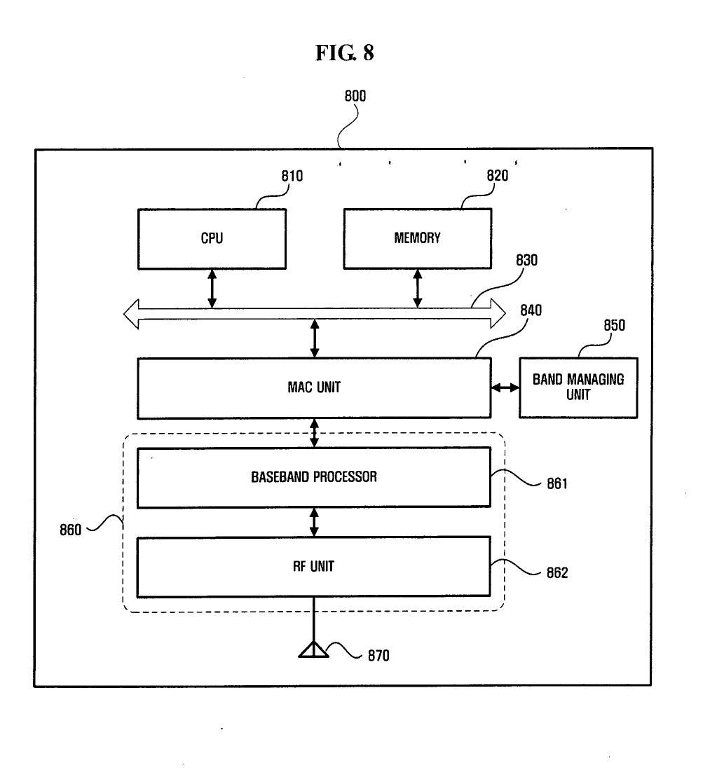

FIG. 8 is a block diagram illustrating a wireless network coordinator according to the exemplary embodiment of the invention. As show in FIG. 8, a wireless network coordinator 800 includes a CPU 810, a memory 820, a MAC unit 840, a band managing unit 850, and a PHY unit 860.

The CPU 810 controls other components connected to a bus 830 and takes charge of the function of the upper layer shown in FIG. 4. Therefore, the CPU 810 processes reception data (reception MSDU: MAC service data unit) supplied from the MAC unit 840 or generates transmission data (transmission MSDU) and supplies the data to the MAC unit 840.

The memory 820 has a function of storing data. The memory 820 is a module capable of inputting/outputting information, such as a hard disk, an optical disk, a flash memory, a compact flash (CF) card, a secure digital (SD) card, a smart media (SM) card, a multimedia card (MMC), or a memory stick. The memory 820 may be provided in the wireless network coordinator 800 or it may be provided in a separate apparatus.

The MAC unit 840 generates a beacon frame for forming a super frame including one or more channel time blocks. The band managing unit 850 allows the wireless network stations on the network to set a specific channel time block among the channel time blocks to a period in which a packing including a certain control command is transmitted or received, that is, a control command period.

In this case, the band managing unit 850 may arrange the control command period immediately behind a beacon period in which the beacon frame is transmitted.

The PHY unit 860 converts the beacon frame generated by the MAC unit 840 into a wireless signal and then transmits the wireless signal through a certain communication channel. In order for this operation, the PHY unit 860 includes a baseband processor 861 and an RF unit 862, and is connected to an antenna 870. The antenna 870 can transmit or receive directional wireless signals in a high-frequency band. A communication channel formed by the RF unit 862 includes a communication channel having a 60 GHz band.

The control command includes the information request command that is generated by one of the wireless network stations on the network that has not received the beacon frame or has received a damaged beacon frame to request schedule information on one or more schedule periods included in the super frame and the information response command that is generated so as to include the schedule information in response to the information request command. The information response command may be generated by the MAC unit 840.

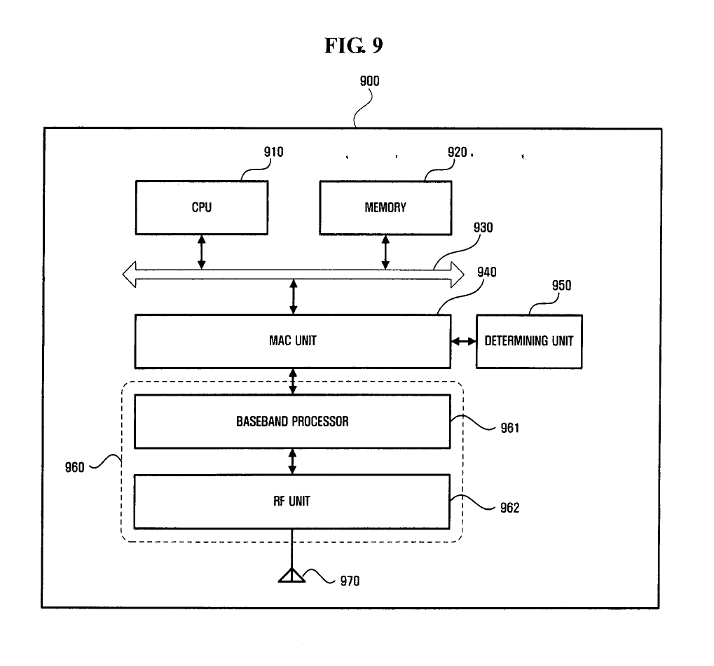

FIG. 9 is a block diagram illustrating a wireless network station according to the exemplary embodiment of the invention. As shown in FIG. 9, a wireless network station 900 includes a CPU 910, a memory 920, a MAC unit 940, a determining unit 950, and a PHY unit 960.

The CPU 910 controls other components connected to a bus 930 and takes charge of the function of the upper layer shown in FIG. 4. Therefore, the CPU 910 processes reception data (reception MSDU: MAC service data unit) supplied from the MAC unit 940 or generates transmission data (transmission MSDU) and supplies the data to the MAC unit 940.

The memory 920 has a function of storing data. The memory 920 is a module capable of inputting/outputting information, such as a hard disk, an optical disk, a flash memory, a compact flash (CF) card, an secure digital (SD) card, an smart media (SM) card, an multimedia card (MMC), or a memory stick. The memory 920 may be provided in the wireless network coordinator 900, or it may be provided in a separate apparatus.

The MAC unit 940 adds a MAC header to MSDU supplied from the CPU 910, that is, data to be transmitted, thereby generating MPDU (MAC protocol data unit).

The PHY unit 960 converts MPDU generated by the MAC unit 940 into a wireless signal and then transmits the wireless signal through a communication channel. In order for this operation, the PHY unit 960 includes a baseband processor 961 and an RF unit 962, and is connected to an antenna 970. The antenna 970 can transmit or receive directional wireless signals in a high-frequency band.

The baseband processor 961 receives MPDU generated by the MAC unit 940 and adds a signal field and a preamble to MPDU to generate PPDU. Then, the RF unit 962 converts the generated PPDU into a wireless signal and then transmits the wireless signal through the antenna 970.

The wireless network station 900 may be allocated with the band of the reserved channel time block included in the super frame in order to perform the function of a transmitting station, or it may contend with other wireless network stations in the unreserved channel time block. In this case, the wireless network station 900 may transmit data through the reserved channel time block having an allocated band with reference to the schedule information of the super frame, or it may contend with other wireless network stations in the unreserved channel time block to transmit the data. Alternatively, the wireless network station 900 may suspend the transmission of data in the reserved channel time block having the band allocated by another wireless network station.

The schedule information can be received through the beacon frame, and the determining unit 950 determines whether the beacon frame is received. A start time of the beacon frame to be transmitted later is specified in the beacon frame, and the determining unit 950 determines whether the beacon frame is received with reference to the beacon frame previously received. In order for this operation, the memory 920 may have the previously received beacon frame stored therein.

Then, the result of the determination is transmitted to the MAC unit 940, and the MAC unit 940 generates a packet (hereinafter, referred to as an information request packet) including an information request command to request the schedule information of the super frame having the beacon frame transmitted thereto. Since the information request command has been described in detail above, a detailed description thereof will be omitted.

The generated information request packet is transmitted to the PHY unit 960, and the PHY unit 960 transmits the received information request packet. That is, the PHY unit 960 transmits the information request packet so that the wireless network coordinator 800 receives it. In order for this operation, the address of the wireless network coordinator 800 may be inserted into the destination field (not shown) of the information request packet, or a broadcast address may be inserted thereinto.

When the information request packet is received, the wireless network coordinator 800 generates a packet (hereinafter, referred to as an information response packet) for the information response command including the schedule information and transmits the packet.

Then, the PHY unit 960 receives the information response packet and transmits the received information response packet to the MAC unit 940. Then, the MAC unit 940 can use the band of the network with reference to the schedule information included in the information response packet.

Meanwhile, when the broadcast address is inserted into the destination field 753, other wireless network stations on the network can also receive the information request packet, which makes it possible for the PHY unit 960 to receive the information response packet from other wireless network stations.

The information request packet and the information response packet may be transmitted or received in the control command period arranged immediately behind the beacon period of the super frame. Since the control command period is an unreserved channel time block, the PHY unit 960 contends with other wireless network stations to transmit the information request packet.

The MAC unit 940 of the wireless network station 900 generates data through the above-mentioned process. The communication channel used for the PHY unit 960 may include a communication channel of a 60 GHz band, and data to be transmitted may be uncompressed data.

Among the wireless network stations provided in the network, the wireless network station provided with the band managing unit 850 may perform the function of the wireless network coordinator 800. That is, the wireless network station may generate a beacon frame and distribute the beacon frame, thereby providing schedule information to other wireless network stations on the network.

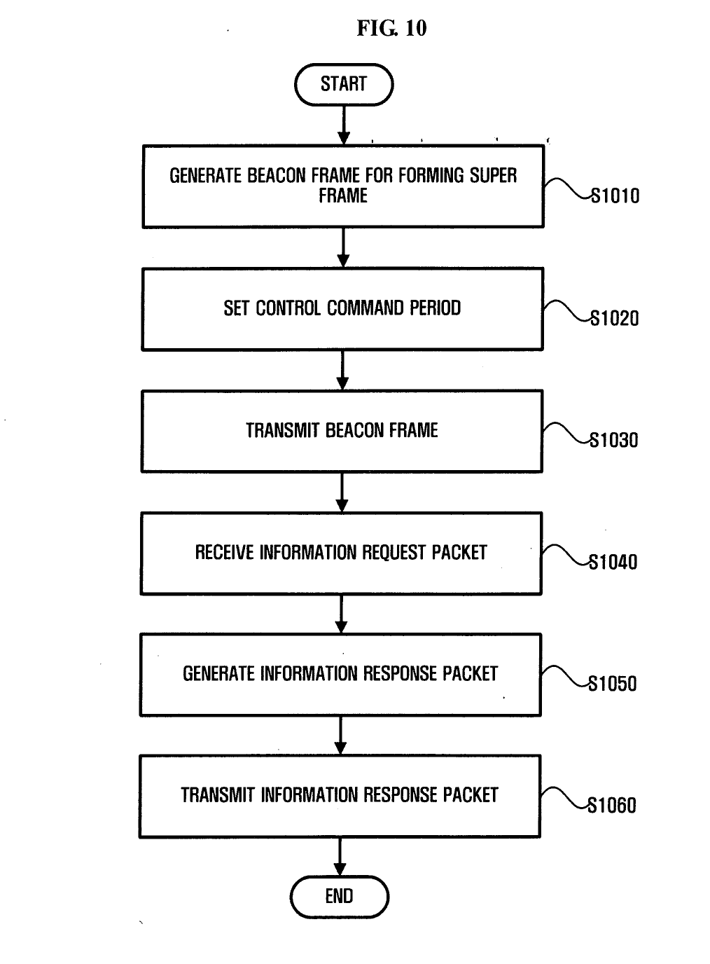

FIG. 10 is a flow chart illustrating the operation of the wireless network coordinator according to the exemplary embodiment of the invention.

The MAC unit 840 of the wireless network coordinator 800 generates a beacon frame for forming a super frame including one or more channel time blocks (S1011). The beacon frame includes schedule information, which is information on the band allocated to the wireless network station on the network.

The band managing unit 850 allows the wireless network stations on the network to set a specific channel time block among the channel time blocks of the super frame to a period (control command period) in which a packet including a certain control command is transmitted or received (S1020). In this case, the control command may include an information request packet and an information response packet.

Then, the PHY unit 860 transmits the beacon frame generated through a certain communication channel (S1030).

Among the wireless network stations on the network, the wireless network station that has not received the beacon frame or has received a damaged beacon frame transmits the information request packet in order to acquire the schedule information included in the beacon frame, and the PHY unit 860 receives the information request packet (S1040). In this case, the information request packet is transmitted in the unreserved channel time block (control command period) of the super frame, and may be arranged immediately behind the beacon period of the super frame.

When the information request packet is received, the MAC unit 840 generates an information response packet in response to the information request packet (S1050). In this case, the information response packet may include the schedule information.

The generated information response packet is transmitted to a corresponding wireless network station in the control command period of the super frame (S1060), and thus the corresponding wireless network station can utilize the network on the basis of the schedule information.

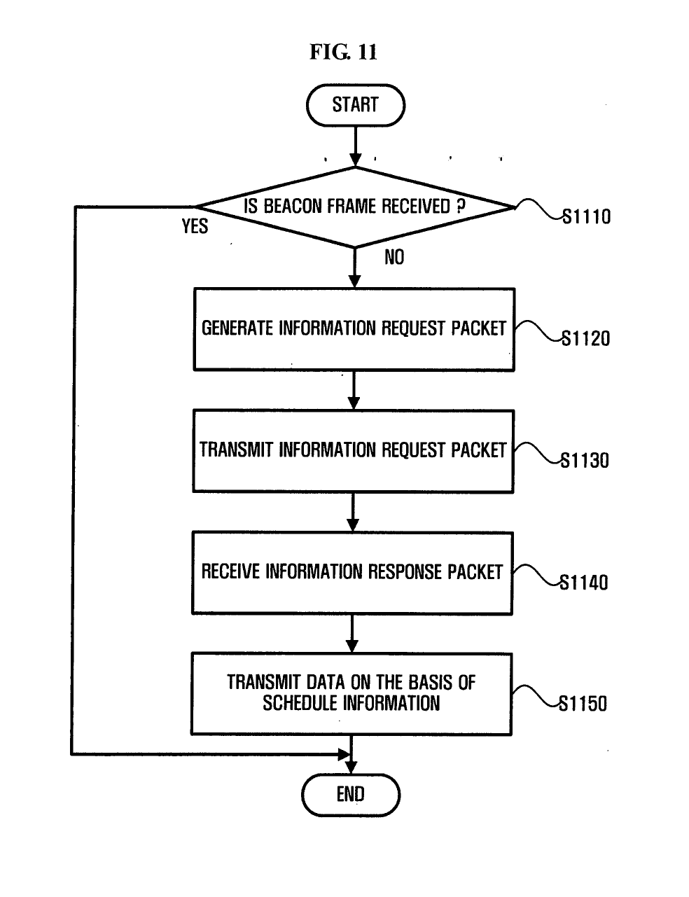

FIG. 11 is a flow chart illustrating the transmission/reception of data by a wireless network station according to the exemplary embodiment of the invention.

The wireless network station 900 that wants to transmit data may transmit the data through the reserved channel time block on the basis of the schedule information included in the beacon frame, or it may contend with other wireless network stations to transmit the data through the unreserved channel time block. In this case, this operation may be performed on the basis of the schedule information on the super frame.

Therefore, the wireless network station 900 that has not received the beacon frame or has received a damaged beacon frame should attempt to acquire the schedule information. In order to acquire the schedule information, first, the determining unit 950 of the wireless network station 900 determines whether the beacon frame is received (S1110) and transmits the result of the determination to the MAC unit 940. When the beacon frame is not received, the MAC unit 940 generates an information request packet (S1120).

Then, the PHY unit 960 transmits the information request packet in the control command period (S1130) and receives an information response packet, which is a response to the transmitted information request packet (S1140). Since the control command period is an unreserved channel time block, the PHY unit 960 contends with other wireless network stations to transmit the information request packet.

Meanwhile, the information response packet is transmitted to the MAC unit 940, and thus the MAC unit 940 can transmit data on the basis of the schedule information included in the information response packet (S1150).

Although the present invention has been described in connection with the exemplary embodiments of the present invention, it will be apparent to those skilled in the art that various modifications and changes of the invention may be made without departing from the scope and spirit of the invention. Therefore, it should be understood that the above exemplary embodiments are not limitative, but illustrative in all aspects.

As described above, according to the wireless network system and the method of transmitting/receiving data over a wireless network of the invention, among wireless network stations performing wireless communication in a high-frequency band, a wireless network station that has not received a beacon frame or has received a damaged beacon frame can acquire schedule information of a super frame, which makes it possible to prevent delay in the transmission of data and to improve the usage efficiency of the super frame.

What is claimed is:

1. A wireless network coordinator comprising:
a media access control (MAC) unit which generates a beacon frame for forming a super frame comprising one or more channel time blocks;
a band managing unit which allows a station on a network to set a specific channel time block among the channel time blocks to a period in which a packet comprising a certain control command is transmitted or received; and
a transmitting unit which transmits the beacon frame comprising information on the setting through a certain communication channel.

2. The wireless network coordinator of claim 1, wherein the specific channel time block is arranged immediately behind a beacon period in which the beacon frame is transmitted in the super frame.

3. The wireless network coordinator of claim 2, wherein the specific channel time block having a certain size is a position behind the beacon period in the super frame.

4. The wireless network coordinator of claim 1, wherein the control command comprises:
an information request command used to request schedule information on one or more schedule periods comprised in the super frame; and
an information response command generated that includes the schedule information in response to the information request command.

5. The wireless network coordinator of claim 4, wherein the information request command comprises at least one of an identifier field indicating that the control command is the information request command, a size field indicating a size of the information request command, and a spare field allocated for various operations on the network.

6. The wireless network coordinator of claim 4, wherein the information request command comprises at least one of an identifier field indicating that the control command is the information response command, a size field indicating a size of the information response command, a spare field allocated for various operations on the network, and a data field having the schedule information specified therein.

7. The wireless network coordinator of claim 4, wherein the schedule information comprises:
an index field indicating that corresponding information is the schedule information;
a size field indicating a size of the schedule information; and
one or more schedule blocks.

8. The wireless network coordinator of claim 7, wherein the schedule block comprises:
a static indication field indicating whether the schedule block is for a static schedule;
a source field indicating a transmitting station that is allowed to allocate a band to one of the channel time blocks;
a destination field indicating a receiving station that receives data from the transmitting station through the channel time block having the band allocated thereto;
a stream index field indicating a type of data;
a start offset field indicating a start time of a specific schedule period corresponding to the schedule block;
a time block duration field indicating a gap between channel time blocks included in the specific schedule period;
a schedule period field indicating an interval between the start times of two continuous channel time blocks comprised in the specific schedule period; and
a number of time blocks field indicating a number of the channel time blocks comprised in the specific schedule period.

9. The wireless network coordinator of claim 1, wherein the channel time block is a time period in which data is transmitted or received among stations on the network.

10. The wireless network coordinator of claim 9, wherein the data comprises uncompressed data.

11. The wireless network coordinator of claim 1, wherein the channel time block comprises:
a reserved channel time block which is a reserved time period in which a band is allocated to a specific station on the network; and
an unreserved channel time block which is a time period in which the band is allocated to one of the stations on the network that is selected by contention.

12. The wireless network coordinator of claim 11, wherein the specific channel time block is the unreserved channel time block.

13. The wireless network coordinator of claim 1, wherein the packet comprising the control command is transmitted or received by a carrier sense multiple access with collision avoidance method or a slotted aloha method.

14. The wireless network coordinator of claim 1, wherein the communication channel comprises a communication channel of a 60 GHz band.

15. A station comprising:
a determining unit which determines whether a beacon frame is received;
a media access control (MAC) unit which generates a packet comprising a first command that is used to request schedule information of a super frame having the beacon frame transmitted thereto according to a result of the determination; and
a transmitting unit which transmits the packet comprising the first command through a specific channel time block of one or more channel time blocks comprised in the super frame and receiving a packet comprising a second command for notifying the schedule information, which is a response to the transmitted packet.

16. The station of claim 15, wherein the specific channel time block is arranged immediately behind a beacon period in which the beacon frame is transmitted in the super frame.

17. The station of claim 16, wherein the specific channel time block having a certain size is at a position behind the beacon period in the super frame.

18. The station of claim 15, wherein the channel time block is a time period in which data is transmitted or received among stations on the network.

19. The station of claim 15, wherein the data comprises uncompressed data.

20. The station of claim 15, wherein the channel time block comprises:
a reserved channel time block which is a reserved time period in which a band is allocated to a specific station on the network; and
an unreserved channel time block which is a time period in which the band is allocated to one of the stations on the network that is selected by contention.

21. The station of claim 20, wherein the specific channel time block is the unreserved channel time block.

22. The station of claim 15, wherein the first command comprises at least one of an identifier field indicating that a corresponding command is the first command, a size field indicating a size of the first command, and a spare field allocated for various operations on the network.

23. The station of claim 15, wherein the second command comprises at least one of an identifier field indicating that a corresponding command is the second command, a size field indicating a size of the second command, a spare field allocated for various operations on the network, and a data field having the schedule information specified therein.

24. The station of claim 15, wherein the schedule information comprises:
an index field indicating that corresponding information is the schedule information;
a size field indicating a size of the schedule information; and
one or more schedule blocks.

25. The station of claim 24, wherein the schedule block comprises:
a static indication field indicating whether the schedule block is for a static schedule;
a source field indicating a transmitting station that is allowed to allocate a band to one of the channel time blocks;
a destination field indicating a receiving station that receives data from the transmitting station through the channel time block having the band allocated thereto;
a stream index field indicating a type of data;
a start offset field indicating a start time of a specific schedule period corresponding to-the schedule block;
a time block duration field indicating a gap between channel time blocks included in the specific schedule period;
a schedule period field indicating an interval between the start times of two continuous channel time blocks comprised in the specific schedule period; and
a number of time blocks field indicating a number of the channel time blocks comprised in the specific schedule period.

26. The station of claim 15, wherein the packet comprising the first command and the packet comprising the second command are transmitted or received by a carrier sense multiple access with collision avoidance method or a slotted aloha method.

27. The station of claim 15, wherein the communication channel comprises a communication channel of a 60 GHz band.

28. The station of claim 15, wherein the transmission unit receives the packet comprising the second command from a wireless network coordinator or anther station on the network according to a destination address of the packet comprising the first command.

29. A method of configuring a network, the method comprising:
generating a beacon frame for forming a super frame comprising one or more channel time blocks;
allowing a station on a network to set a specific channel time block among the channel time blocks to set a period in which a packet comprising a certain control command is transmitted or received; and
transmitting the beacon frame comprising information on the setting through a certain communication channel.

30. The method of claim 29, wherein the specific channel time block is arranged immediately behind a beacon period in which the beacon frame is transmitted in the super frame.

31. The method of claim 30, wherein the specific channel time block having a certain size is a position behind the beacon period in the super frame.

32. The method of claim 29, wherein:
the control command comprises:
an information request command used to request schedule information on one or more schedule periods comprised in the super frame; and
an information response command generated that includes the schedule information in response to the information request command.

33. The method of claim 32, wherein the information request command comprises at least one of an identifier field indicating that the control command is the information request command, a size field indicating a size of the information request command, and a spare field allocated for various operations on the network.

34. The method of claim 32, wherein the information response command comprises at least one of an identifier field indicating that the control command is the information response command, a size field indicating a size of the information response command, a spare field allocated for various operations on the network, and a data field having the schedule information specified therein.

35. The method of claim 32, wherein the schedule information comprises index field indicating that corresponding information is the schedule information;
a size field indicating a size of the schedule information; and
one or more schedule blocks.

36. The method of claim 35, wherein the schedule block comprises:
a static indication field indicating whether the schedule block is for a static schedule;
a source field indicating a transmitting station that is allowed to allocate a band to one of the channel time blocks;
a destination field indicating a receiving station that receives data from the transmitting station through the channel time block having the band allocated thereto;
a stream index field indicating a type of data;
a start offset field indicating a start time of a specific schedule period corresponding to the schedule block;
a time block duration field indicating a gap between channel time blocks included in the specific schedule period;
a schedule period field indicating an interval between the start times of two continuous channel time blocks comprised in the specific schedule period; and
a number of time blocks field indicating the number of channel time blocks comprised in the specific schedule period.

37. The method of claim 29, wherein the channel time block is a time period in which data is transmitted or received among stations on the network.

38. The method of claim 37, wherein the data comprises uncompressed data.

39. The method of claim 29, wherein the channel time block comprises:
a reserved channel time block which is a reserved time period in which a band is allocated to a specific station on the network; and
an unreserved channel time block which is a time period in which the band is allocated to one of the stations on the network that is selected by contention.

40. The method of claim 39, wherein the specific channel time block is the unreserved channel time block.

41. The method of claim 29, wherein the packet comprising the control command is transmitted or received by a carrier sense multiple access with collision avoidance method or a slotted aloha method.

42. The method of claim 29, wherein the communication channel comprises a communication channel of a 60 GHz band.

43. A method of transmitting/receiving data, the method comprising:
determining whether a beacon frame is received;
generating a packet comprising a first command that is used to request schedule information of a super frame having the beacon frame transmitted thereto according to a result of the determination;
transmitting the packet comprising the first command through a specific channel time block of one or more channel time blocks comprised in the super frame; and
receiving a packet comprising a second command for notifying the schedule information, which is a response to the transmitted packet.

44. The method of claim 43, wherein the specific channel time block is arranged immediately behind a beacon period in which the beacon frame is transmitted in the super frame.

45. The method of claim 44, wherein the specific channel time block having a certain size is at a position behind the beacon period in the super frame.

46. The method of claim 43, wherein the channel time block is a time period in which data is transmitted or received among stations on the network.

47. The method of claim 46, wherein the data comprises uncompressed data.

48. The method of claim 43, wherein the channel time block comprises served channel time block which is a reserved time period in which a band is allocated to a specific station on the network; and
an unreserved channel time block which is a time period in which the band is allocated to one of the stations on the network that is selected by contention.

49. The method of claim 48, wherein the specific channel time block is the unreserved channel time block.

50. The method of claim 43, wherein the first command comprises at least one of an identifier field indicating that a corresponding command is the first command, a size field indicating a size of the first command, and a spare field allocated for various operations on the network.

51. The method of claim 43, wherein the second command comprises at least one of an identifier field indicating that a corresponding command is the second command, a size field indicating a size of the second command, a spare field allocated for various operations on the network, and a data field having the schedule information specified therein.

52. The method of claim 43, wherein the schedule information comprises:
an index field indicating that corresponding information is the schedule information;
a size field indicating a size of the schedule information; and
one or more schedule blocks.

53. The method of claim 52, wherein the schedule block comprises:
a static indication field indicating whether the schedule block is for a static schedule;
a source field indicating a transmitting station that is allowed to allocate a band to one of the channel time blocks;
a destination field indicating a receiving station that receives data from the transmitting station through the channel time block having the band allocated thereto;
a stream index field indicating a type of data;
a start offset field indicating a start time of a specific schedule period corresponding to the schedule block;
a time block duration field indicating a gap between channel time blocks included in the specific schedule period;
a schedule period field indicating an interval between the start times of two continuous channel time blocks comprised in the specific schedule period; and
a number of time blocks field indicating a number of the channel time blocks comprised in the specific schedule period.

54. The method of claim 43, wherein the packet comprising the first command and the packet comprising the second command are transmitted or received by a carrier sense multiple access with collision avoidance method or a slotted aloha method.

55. The method of claim 43, wherein the communication channel comprises a communication channel of a 60 GHz band.

56. The method of claim 43, wherein the receiving of the packet comprising the second command comprises receiving the packet comprising the second command from a wireless network coordinator or anther station on the network according to a destination address of the packet comprising the first command.

57. A data structure stored in a computer readable memory comprising:
a static indication field indicating whether a schedule block having schedules for one or more channel time blocks included in a super frame specified therein is for a static schedule;
a source field indicating a transmitting station that is allowed to allocate a band to one of the channel time blocks;
a destination field indicating a receiving station that receives data from the transmitting station through the channel time block having the band allocated thereto;
a stream index field indicating a type of data;
a start offset field indicating a start time of a specific schedule period corresponding to the schedule block;
a time block duration field indicating a gap between channel time blocks included in the specific schedule period;
a schedule period field indicating an interval between the start times of two continuous channel time blocks comprised in the specific schedule period; and
a number of time blocks field indicating a number of the channel time blocks comprised in the specific schedule period.

58. The data structure of claim 57, wherein the static schedule comprises a schedule of the channel time block that exists at a certain time in a certain period of the super frame.
